(19) United States
(12) Patent Application Publication
(10) Pub. No.: US 2012/0199497 A1
(43) Pub. Date: Aug. 9, 2012

(54) ELECTROCHEMICAL-BASED ANALYTICAL TEST STRIP WITH DIFFUSION-CONTROLLING LAYER AND METHOD FOR DETERMINING AN ANALYTE USING SUCH AN TEST STRIP

(75) Inventors: Zuifang Liu, Inverness (GB); Marco F. Cardosi, Inverness (GB); Christopher Philip Leach, Inverness (GB); Scott Sloss, Inverness (GB)

(73) Assignee: LifeScan Scotland Limited, Inverness (GB)

(21) Appl. No.: 13/021,956

(22) Filed: Feb. 7, 2011

(51) Int. Cl. G01N 27/26

(52) U.S. Cl. 205/777.5; 204/403.14

(57) ABSTRACT

An electrochemical-based analytical test strip for the determination of an analyte (such as glucose) in a bodily fluid sample (e.g., a whole blood sample) includes a substrate, at least one working electrode disposed on the substrate, a sample-soluble enzymatic reagent layer disposed above the working electrode, a diffusion-controlling layer (DCL) disposed between the at least one working electrode and the sample-soluble enzymatic reagent layer; and a sample-receiving chamber. In addition, the sample-soluble enzymatic reagent layer is configured and constituted for operable solubility in a bodily fluid sample applied to the electrochemical-based analytical test strip and received in the sample-receiving chamber and for electrochemical enzymatic reaction with an analyte in the bodily fluid sample. Moreover, the DCL is configured and constituted to provide a predetermined diffusion rate for a component (for example a mediator) of the electrochemical enzymatic reaction through the DCL that is less than the diffusion rate of the component through the bodily fluid sample and for operable hydration by the bodily fluid sample. A method for determining an analyte in a bodily fluid sample includes applying a bodily fluid sample to an electrochemical-based analytical test strip that includes a substrate, at least one working electrode disposed on the substrate, a sample-soluble enzymatic reagent layer disposed above the working electrode, a DCL disposed between the at least one working electrode and the sample-soluble enzymatic reagent layer; and a sample-receiving chamber defined in the electrochemical-based analytical test strip.

### BACKGROUND OF THE INVENTION

1. Field of the Invention

The present invention relates, in general, to medical devices and, in particular, to analytical test strips and related methods.

2. Description of Related Art

The determination (e.g., detection and/or concentration measurement) of an analyte in a fluid sample is of particular interest in the medical field. For example, it can be desirable to determine glucose, ketone bodies, cholesterol, lipoproteins, triglycerides, acetaminophen and/or HbA1 c concentrations in a sample of a bodily fluid such as urine, blood, plasma or interstitial fluid. Such determinations can be achieved analytical test strips (e.g., electrochemical-based analytical test strips) and an associated test meter.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings, in which like numerals indicate like elements, of which:

FIG. 1 is a simplified, exploded, perspective view of an electrochemical-based analytical test strip according to an embodiment of the present invention;

FIG. 2 is a simplified cross-sectional depiction of a portion of the patterned electrode layer, diffusion-controlling layer, sample-soluble enzymatic reagent layer and sample-receiving chamber of the electrochemical-based analytical test strip of FIG. 1 prior to, and following, introduction of a bodily fluid sample (whole blood), that illustrates various features of the present invention;

FIG. 3 is a graph of plasma glucose concentration versus 5 second measurement current for an electrochemical-based analytical test strip devoid of a diffusion-controlling layer;

FIG. 4 is a graph of plasma glucose concentration versus 5 second measurement current for an electrochemical-based analytical test strip according to an embodiment of the present invention that includes a diffusion-controlling layer (DCL) and a sample-soluble enzymatic reagent layer;

FIG. 5 is a graph of Hematocrit (Hct) in a bodily fluid sample versus the associated calibration slope for electrochemical-based analytical test strips according to embodiments of the present invention with DCL thicknesses of 1.85 μm, 3.70 μm, and 5.56 μm, as well as a comparison electrochemical-based analytical test strip devoid of a DCL layer (also referred to as a 0.00 μm thick layer); and

FIG. 6 is a flow diagram depicting stages in a method for determining an analyte in a bodily fluid sample according to an embodiment of the present invention.

### DETAILED DESCRIPTION OF ILLUSTRATIVE EMBODIMENTS

The following detailed description should be read with reference to the drawings, in which like elements in different drawings are identically numbered. The drawings, which are not necessarily to scale, depict exemplary embodiments for the purpose of explanation only and are not intended to limit the scope of the invention. The detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention.

As used herein, the terms “about” or “approximately” for any numerical values or ranges indicate a suitable dimensional tolerance that allows the part or collection of components to function for its intended purpose as described herein.

In general, electrochemical-based analytical test strips for the determination of an analyte (such as glucose) in a bodily fluid sample (e.g., a whole blood sample) according to embodiments of the present invention include a substrate, at least one working electrode disposed on the substrate, a sample-soluble enzymatic reagent layer disposed above the working electrode, a diffusion-controlling layer (DCL) disposed between the at least one working electrode and the sample-soluble enzymatic reagent layer; and a sample-receiving chamber. In addition, the sample-soluble enzymatic reagent layer is configured and constituted for operable solubility in a bodily fluid sample applied to the electrochemical-based analytical test strip and received in the sample-receiving chamber and for electrochemical enzymatic reaction with an analyte in the bodily fluid sample. Moreover, the DCL is configured and constituted to provide a predetermined diffusion rate for a component (for example a mediator) of the electrochemical enzymatic reaction through the DCL that is less than the diffusion rate of that component through the bodily fluid sample and for operable hydration by the bodily fluid sample.

Electrochemical-based analytical test strips according to the present invention are particularly beneficial in that the electrochemical response (for example, a measurement current) is predominantly determined by the diffusion rate of the component through the DCL and not through the bulk solution. In this regard, the bulk solution is considered to be the bodily fluid sample plus the sample-soluble enzymatic reagent solution that is dissolved therein. However, since the diffusion properties of the bodily fluid sample still predominate in the bulk solution, it is sufficient to state that the electrochemical response of the electrochemical-based analytical test strip (e.g., a measurement current) is predominantly determined by the diffusion rate of the component through the DCL and not through the bodily fluid sample.

Due to the predominance of the diffusion rate through the DCL, deleterious measurement effects due to variation in component diffusion through the bodily fluid sample are significantly reduced. One such deleterious effect for the determination of glucose in whole blood samples using conventional electrochemical-based analytical test strips is a decrease in measurement current as Hematocrit of the whole blood sample increases (noting that Hematocrit (Hct) is the proportion, by volume, of the whole blood sample that consists of red blood cells and is expressed as a percentage). For a conventional electrochemical-based analytical test strip, the electrochemical response (e.g., current) to blood glucose can vary significantly with sample hematocrit (Hct), leading to reduced measurement accuracy. Therefore, the associated test meter may employ a complicated algorithm to correct electrochemical responses since the Hct range of clinical interest is wide.

However, for electrochemical-based analytical test strips according to an embodiment of the present invention, the diffusion rate through the DCL is always slower than the diffusion rate in the whole blood sample regardless of the Hct of the whole blood sample (for a clinically significant Hct range of 0% to approximately 60%), thus reducing the effect Hct on electrochemical response and increasing analytical accuracy. In other words, electrochemical-based test strips according to embodiments of the present invention are beneficially insensitive to Hct in a whole blood sample since the supply of mediator to the working electrode is rendered insensitive to Hct. Their relative insensitivity also provides the benefit of enabling use of a test meter with a simplified algorithm.

It should be noted that a relatively slow diffusion rate through the DCL can lower the electrochemical response and thus reduce analyte sensitivity. Therefore, the diffusion rate through the DCL should be predetermined to achieve the benefits described above (for example, reduced sensitivity to Hct) while still providing an electrochemical-based analytical test strip with adequate analyte sensitivity. For example, for the determination of glucose in whole blood samples with an Hct as high as 60% using an enzymatic reaction that includes a ferrocyanide mediator component, the DCL can have a diffusion coefficient for ferrocyanide in the range of 1×10⁻⁶ cm²/sec to 1×10⁻⁸ cm²/sec. Such diffusion coefficients are less than the estimated diffusion coefficient of ferrocyanide in a 60% Hct whole blood sample, i.e., 1.27×10⁻⁶ cm²/sec, and less than the estimated diffusion coefficient of ferrocyanide in plasma, i.e., 5×10⁻⁶ cm²/sec.

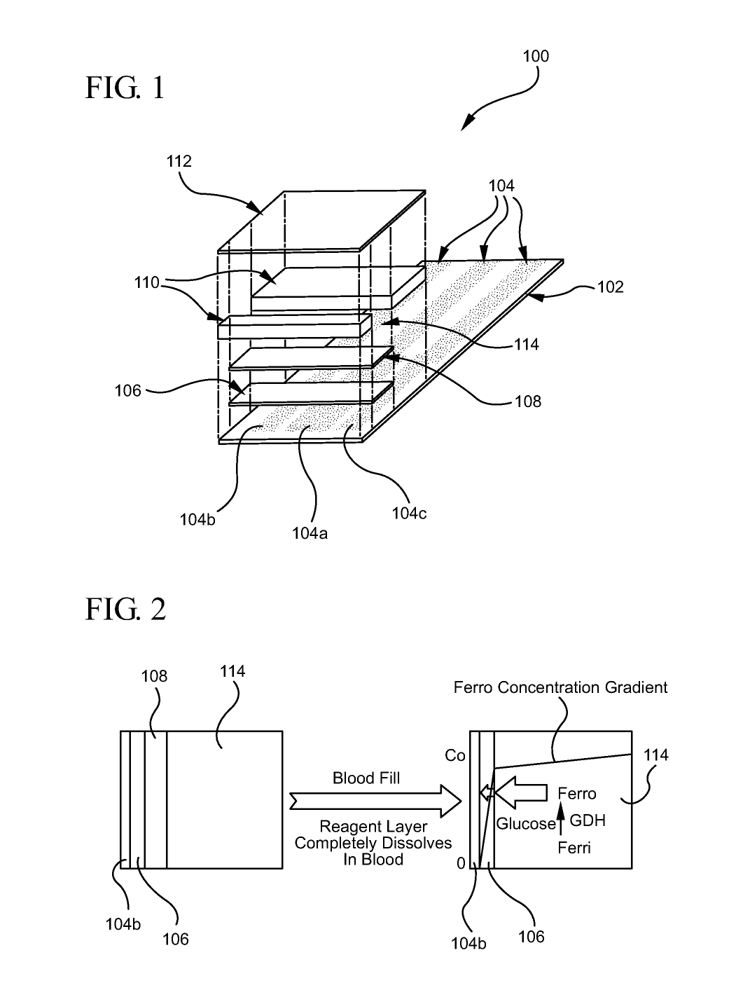

FIG. 1 is a simplified, exploded, perspective view of an electrochemical-based analytical test strip 100 according to an embodiment of the present invention wherein the dashed lined indicate alignment of various elements of electrochemical-based analytical test strip 100. FIG. 2 is a simplified cross-sectional depiction of a portion of the working electrode, diffusion-controlling layer (DCL), sample-soluble enzymatic reagent layer and sample-receiving chamber of electrochemical-based analytical test strip 100. FIG. 2 depicts various features of the present invention prior to, and following, introduction of a bodily fluid sample (whole blood) into the sample chamber.

Referring to FIGS. 1 and 2, electrochemical-based analytical test strip 100 includes an electrically-insulating substrate 102, a patterned conductor layer 104, a diffusion-controlling layer (DCL) 106, a sample-soluble enzymatic reagent layer 108, a patterned spacer layer 110, and a top film 112. Electrochemical-based analytical test strip 100 also includes a sample-receiving chamber 114 formed therein with patterned spacer layer 110 defining outer walls of sample-receiving chamber 114.

Patterned conductor layer 104 includes three electrodes, a counter electrode 104a (also referred to as a reference electrode), a first working electrode 104b and a second working electrode 104c.

During use of electrochemical-based analytical test strip 100 to determine an analyte in a bodily fluid sample (e.g., blood glucose concentration in a whole blood sample), electrodes 104a, 104b and 104c are employed by an associated meter (not shown) to monitor an electrochemical response of the electrochemical-based analytical test strip. The electrochemical response can be, for example, an electrochemical reaction induced current of interest. The magnitude of such a current can then be correlated with the amount of analyte present in the bodily fluid sample under investigation. During such use, a bodily fluid sample is applied to electrochemical-based analytical test strip 100 and, thereby, received in sample-receiving chamber 114.

In electrochemical-based analytical test strip 100, sample-soluble enzymatic reagent layer 108 is configured and constituted for operable solubility in the bodily fluid sample and for electrochemical enzymatic reaction with an analyte in the bodily fluid sample; and (see, in particular, the non-limiting example depicted in FIG. 2). Sample-soluble enzymatic reagent layer 108 undergoes fast dissolution as the bodily fluid sample (blood in the embodiment of FIG. 2) is introduced into the sample receiving chamber. As a result, an enzymatic reaction that includes ferrocyanide generation occurs predominantly in the bulk solution (see the right-hand-side of FIG. 2 where ferricyanide is abbreviated as “Ferri” and ferrocyanide is abbreviated as “Ferro”). Such a fast dissolution can occur, for example, in a period of less than 3-4 seconds for an analyte determination that relies on a measurement made 5 seconds after bodily fluid sample introduction. However, it is also noted that the fastest suitable dissolution of the sample-soluble reagent layer is preferred since early dissolution can provide adequate time for the electrochemical reaction to reach an operative state (e.g., an operative steady state) while also providing a beneficially short analyte determination time period.

Once apprised of the present disclosure, one skilled in the art will recognize that electrochemical-based analytical test strips according to the present invention can take any suitable configuration including, for example, configurations wherein the working and counter/reference electrodes are in a co-planar configuration (as depicted in FIG. 1) or an opposing configuration. Moreover the configuration can be such that the sample-receiving chamber of the electrochemical-based analytical test strip is designed for side-fill (as in FIG. 1) or end-fill. Moreover, the DCL can be disposed directly on only the working electrode(s) or on both the working electrode(s) and a counter electrode (as shown in FIG. 1). Furthermore, although electrochemical-based analytical test strip 100 is depicted as including three co-planar electrodes, embodiments of electrochemical-based analytical test strips according to the present invention can include any suitable number of electrodes.

Electrically-insulating substrate 102 can be any suitable electrically-insulating substrate known to one skilled in the art including, for example, a nylon substrate, polycarbonate substrate, a polyimide substrate, a polyvinyl chloride substrate, a polyethylene substrate, a polypropylene substrate, a glycolated polyester (PETG) substrate, a polystyrene substrate, a silicon substrate, ceramic substrate, glass substrate or a polyester substrate (e.g., a 7 mil thick polyester substrate). The electrically-insulating substrate can have any suitable dimensions including, for example, a width dimension of about 5 mm, a length dimension of about 27 mm and a thickness dimension of about 0.5 mm.

Patterned conductor layer 104 can be formed of any suitable electrically conductive material such as, for example, gold, palladium, carbon, silver, platinum, tin oxide, iridium, indium, or combinations thereof (e.g., indium doped tin oxide). Moreover, any suitable technique or combination of techniques can be employed to form patterned conductive layer 104 including, for example, sputtering, evaporation, electro-less plating, screen-printing, contact printing, laser ablation or gravure printing. A typical but non-limiting thickness for a patterned gold conductor layer is in the range of 5 nm to 100 nm.

Diffusion controlling layer (DCL) 106 is configured and constituted (i) to provide a predetermined diffusion rate for a component of the electrochemical enzymatic reaction through the DCL that is less than the diffusion rate of the component through the bodily fluid sample and (ii) for operable hydration (i.e., combination with water) by the bodily fluid sample.

The DCL can be made of (i.e. be constituted of) any suitable material, including but not limited to, water-soluble polymers. Suitable materials include materials that undergo fast hydration when exposed to a bodily fluid sample, but operably slow dissolution during determination of an analyte in the bodily fluid sample. In other words, the DCL should wet almost immediately to allow diffusion/penetration of the component (e.g., ferrocyanide generated by an enzymatic reaction in a whole blood sample which is oxidized at the working electrode surface to produce a measurement current), whilst not fully dissolving within the time period of analyte determination (e.g., not within a five second analyte determination time period) such that DCL integrity is maintained.

The diffusion rate of a component (e.g., the mediator ferrocyanide) through a DCL can be tailored via factors related to the DCL's configuration (for example, thickness of the DCL layer) and its constitution (i.e., the chemical composition of the DCL). An increase in the thickness of a DCL layer leads to a decrease in diffusion rate, and vice versa. Although dependent on the particular chemical constitution of the DCL, a typical thickness of the DCL is, for example, from 0.1 to 30 microns, preferably from 1 to 15 microns, and more preferably from 3 to 10 microns.

It should be noted that the diffusion coefficient, and hence diffusion rate, of component molecules through a DCL varies with intermolecular forces (e.g., ionic attraction/repulsion, hydrogen bonding, van der Waals forces, etc.) between the component molecules and the DCL material. The stronger the intermolecular forces, the lower the diffusion coefficient and the slower the diffusion rate.

For a DCL formed of a suitable hydrophilic polymer(s), the hydration process of the polymer(s) is another characteristic that can be exploited to tailor the diffusion coefficient and, hence, the diffusion rate. Generally speaking, a fast hydration will facilitate diffusion through the hydrated DCL. The hydration of a polymer(s) depends on both its physical properties (e.g., molecular weight, polydispersity index, crystallinity, etc.) and its chemical composition/structures (e.g., charges, polarity, branching, cross-linking, etc.). As previously mentioned, it is beneficial for the DCL should have a well-balanced hydration and dissolution. This can be realized by, for example, forming the DCL of a suitable single polymer or a combination of two or more polymers.

Any suitable hydrophilic polymers can be used to constitute the DCL including, but not limited to, both homo-polymers and copolymers (such as random copolymers, block copolymers, graft copolymers, etc.) of polyacrylamide, poly(2-hydroxyethyl methacrylate), poly(acrylic acid), poly(vinyl alcohol), polyvinyl pyrrolidone, hydroxyethyl cellulose, polyethylene glycol, polyoxyethylenbe, carboxymethyl cellulose, poly(acrylamide-co-acrylic acid), and poly(ethylene glycol-b-propylene glycol).

The DCL can, for example, constitute a cross-linked polymer that hydrates quickly to form a hydrogel, but will essentially not dissolve in a whole blood sample or other aqueous bodily fluid sample during the analyte determination time period. One skilled in the art will recognize that the operative absence of dissolution of a cross-linked polymer during analyte determination is a function of, for example, polymer macromolecular chain entanglement and viscosity. The diffusion coefficient, and thus the diffusion rate, of the DCL can be tailored by various means, including, but not limited to, polymer hydrophilicity, polymer molecular weight and polydispersity (molecular weight distribution).

One skilled in the art will recognize that conventional electrochemical-based analyte test strips employ a working electrode along with an associated counter/reference electrode and enzymatic reagent to facilitate an electrochemical reaction with an analyte of interest and, thereby, determine the presence and/or concentration of that analyte. For example, an electrochemical-based analyte test strip for the determination of glucose concentration in a blood sample can employ an enzymatic reagent that includes the enzyme glucose oxidase and the mediator ferricyanide, which undergoes a transformation into the mediator ferrocyanide during the enzymatic reaction (see FIG. 2). Such conventional analyte test strips and enzymatic reagent layers are described in, for example, U.S. Pat. Nos. 5,708,247; 5,951,836; 6,241,862; and 6,284,125; each of which is hereby incorporated in full by reference. In this regard, the sample-soluble enzymatic reagent layer employed in embodiments of the present invention can include any suitable sample-soluble enzymatic reagents, with the selection of enzymatic reagents being dependent on the analyte to be determined and the bodily fluid sample. For example, if glucose is to be determined in a blood sample, sample-soluble enzymatic reagent layer 108 can include glucose oxidase or glucose dehydrogenase along with other components necessary for functional operation including solubility in a bodily fluid sample.

Once apprised of the present disclosure, one skilled in the art will also recognize that sample-soluble enzymatic reagent layer 108 fully dissolves in the bodily fluid sample (thereby forming a bulk solution of bodily fluid sample and dissolved sample-soluble enzymatic reagent layer) and selectively reacts with an analyte, such as, for example glucose, in the bodily fluid sample to form an electroactive species, which can then be quantitatively measured at a working electrode of electrochemical-based analytical test strips according to embodiments of the present invention.

In general, sample-soluble enzymatic reagent layer 108 includes at least an enzyme and a mediator. Examples of suitable mediators include, for example, ferricyanide, ferrocene, ferrocene derivatives, osmium bipyridyl complexes, and quinone derivatives. Examples of suitable enzymes include glucose oxidase, glucose dehydrogenase (GDH) using a pyrroloquinoline quinone (PQQ) co-factor, GDH using a nicotinamide adenine dinucleotide (NAD) co-factor, and GDH using a flavin adenine dinucleotide (FAD) co-factor. Sample-soluble enzymatic reagent layer 108 can be applied during manufacturing using any suitable technique.

Once apprised of the present disclosure, one skilled in the art will recognize that sample-soluble enzymatic reagent layer 108 can, if desired, also contain suitable buffers (such as, for example, Tris HCl, Citraconate, Citrate and Phosphate), surfactants to facilitate dissolution (for example, Triton X100, Tergitol surfactants, Pluronic F68, Betaine and Igepal), thickeners (including, for example, hydroxyethylcelulose (HEC), carboxymethylcellulose, ethycellulose and alginate), enzyme stabilizers and other additives as are known in the field.

Further details regarding the use of electrodes and enzymatic reagent layers for the determination of the concentrations of analytes in a bodily fluid sample, albeit without the present combination of a DCL and sample-soluble enzymatic reagent layer, are in U.S. Pat. No. 6,733,655, which is hereby fully incorporated by reference.

Patterned spacer layer 110 can be formed of any suitable material including, for example, a 95 μm thick, double-sided pressure sensitive adhesive layer, a heat activated adhesive layer, or a thermo-setting adhesive plastic layer. Patterned spacer layer 110 can have, for example, a thickness in the range of from about 1 micron to about 500 microns, preferably between about 10 microns and about 400 microns, and more preferably between about 40 microns and about 200 microns.

Electrochemical-based analytical test strip 100 can be manufactured, for example, by the sequential aligned formation of patterned conductor layer 104, DCL 106, sample-soluble enzymatic reagent layer 108, patterned spacer layer 110, and top film 112 onto electrically-insulating substrate 102. Any suitable techniques known to one skilled in the art can be used to accomplish such sequential aligned formation, including, for example, screen printing, photolithography, photogravure, chemical vapour deposition, sputtering, tape lamination techniques and combinations thereof.

For example, formation of a DCL can be accomplished by depositing a suitable polymer solution on the surface of the working electrode, followed by drying of the deposited polymer solution using infrared (IR) heat or hot air.

Experimental Study 1

Electrochemical-based analytical test strips according to the present invention configured for side-fill of a sample-receiving chamber were fabricated with a DCL thickness of approximately 3 μm (in a dry, i.e., non-hydrated, state) and a DCL thickness of approximately 6 μm (also in a dry state). Comparison electrochemical-based analytical test strips without a DCL layer was also fabricated.

The fabricated electrochemical-based analytical test strips included a single gold counter electrode and two gold working electrodes on a polyester electrically insulating substrate. The working and counter electrodes were formed by laser ablation patterning of a deposited gold layer. The width of the counter electrode was 1.8 mm and the width of the working electrode was 0.9 mm. The electrodes were separated from one another by a gap of 0.2 mm.

The fabricated electrochemical-based analytical test strips also included a patterned spacer layer of double-sided tape with a 1 mm wide channel running over the working and counter electrodes to form a sample-receiving chamber. For the electrochemical-based analytical test strips fabricated with a DCL, a continuous polymer DCL was formed by IR drying of a 2% solid content aqueous solution of poly(acrylamide-co-acrylic acid) with an average molecular weight of 20 kg/mol (commercially available from Sigma-Aldrich as Catalog Numbers 511463) deposited within the 1 mm wide channel.

The sample-soluble enzymatic reagent of the fabricated electrochemical-based analytical test strips was deposited on the formed continuous polymer DCL and dried using IR. The deposited reagent solution had the reagent composition detailed in Table 1 below. The top film was a polymer sheet attached to the patterned spacer layer.

TABLE 1
Experimental Study 1 Reagent Composition

| Material | Amount | |
|---|---|---|
| FAD-GDH (Toyobo, Japan) | 0.06 | g |
| Potassium ferricyanide (Sigma Aldrich) | 0.6 | g |
| Buffer ⁽¹⁾ | 10 | mL |

⁽¹⁾ Buffer composition: 0.5 g Pluronic P103, 0.26 g Pluronic F67, 15.0 g sucrose, 0.3 g citraconic acid, and 1.0 g dipotassium citraconate.

The electrochemical-based analytical test strips fabricated for

Experimental Study 1 were tested at room temperature by applying a 400 mV potential between the working electrode and the counter/reference electrode for 5 seconds (with no poise delay). Eight replicate electrochemical-based analytical test strips were tested for across a range of Hct (plasma at 0% to 59.3%) and blood glucose levels as described below.

For the electrochemical-based analytical test strips fabricated without a DCL, a linear fit between Hct (in the range of 0 percent to 59.3% percent) and electrochemical response (measured as a 5 second current in micro-amps) had a slope of −0.061 (glucose concentrations in the range of 449-455 mg/dl). A linear fit between blood glucose concentration (in the range of 72 to 455 mg/dl) and the electrical response had a slope of 0.0176 for plasma and 0.01 for a whole blood sample with an Hct of 59.3%.

For the electrochemical-based analytical test strips fabricated with a DCL having a thickness of approximately 3 μm, a linear fit between Hct (in the range of 0 percent to 59.3 percent) and electrochemical response (measured as a 5 second current in micro-amps) had a slope of −0.0186 (glucose concentrations in the range of 449-455 mg/dl). A linear fit between blood glucose concentration (in the range of 72 to 455 mg/dl) and the electrical response had a slope of 0.0092 for plasma and 0.0059 for a whole blood sample with an Hct of 59.3%.

For the electrochemical-based analytical test strips fabricated with a DCL having a thickness of approximately 6 μm, a linear fit between Hct (in the range of 0 percent to 59.3 percent) and electrochemical response (measured as a 5 second current in micro-amps) had a slope of +0.0043 (glucose concentrations in the range of 449-455 mg/dl). A linear fit between blood glucose concentration (in the range of 72 to 455 mg/dl) and the electrical response had a slope of 0.0029 for a whole blood sample with an Hct of 59.3%.

The experimental slope data clearly illustrates that electrochemical-based analytical test strips according to embodiments of the present invention (i.e., the experimental strips with a DCL) produced electrochemical responses that were significantly less sensitive to Hct across the tested glucose range than the comparison electrochemical-based analytical test strip without a DCL. This lower sensitivity indicates that electrochemical-based analytical test strips according to embodiments of the present invention will provide improved analyte determination accuracy.

Experimental Study 2

Electrochemical-based analytical test strips according to the present invention configured for the end-fill of a sample-receiving chamber were fabricated with a dry DCL thickness of approximately 1.85 μm, a dry DCL thickness of approximately 3.70 μm, and a dry DCL thickness of approximately 5.56 μm. Comparison electrochemical-based analytical test strips without a DCL layer was also fabricated.

The fabricated electrochemical-based analytical test strips included a single gold counter electrode and two gold working electrodes on a polyester electrically insulating substrate. The working and counter electrodes were formed by laser ablation patterning of a deposited gold layer.

For the electrochemical-based analytical test strips fabricated with a DCL, a continuous polymer DCL was formed by IR drying of an aqueous solution containing a mixture of two polymers (2% solid content) deposited on the working and counter electrodes. The two types of polymer were poly (acrylamide-co-acrylic acid) with an average molecular weight of 20 kg/ml and an average molecular weight of 5000 kg/mol, respectively (commercially available from Sigma-Aldrich as Catalog Numbers 511463 and 181277, respectively). The weight ratio of the 20 kg/mol MW polymer to the 5000 kg/mol MW polymer was 4:1.

The sample-soluble enzymatic reagent of the fabricated electrochemical-based analytical test strips was deposited on the formed continuous polymer DCL and dried using IR. The deposited reagent solution had the dry reagent components listed in Table 2 below.

TABLE 2
Experimental Study 2 Dry Reagent Components

| Material | Amount (in 1000 ml) |
|---|---|
| Citraconate buffer (pH 7) | 1000 mL |
| Calcium chloride | 0.144 g ± 0.001 g |
| Pluronic P103 | 0.258 ± 0.001 |
| Pluronic F67 | 0.258 ± 0.001 g |
| Sucrose | 15.36 ± 0.05 g |
| Flavin-adenine dinucleotide | 22.5 ± 0.125 g |
| dependent glucose dehydrogenase | |
| (“FAD-GDH”) enzyme | |
| Potassium ferricyanide | 296.3 ± 0.25 g |

The fabricated electrochemical-based analytical test strips also included a combined patterned spacer layer and top film of laminated tape with a pre-formed channel (of 5.0×1.0×0.11 mm (length x width x height)) disposed over the working and counter electrodes to form a sample-receiving chamber.

The electrochemical-based analytical test strips fabricated for

Experimental Study 2 were tested under the same conditions as describe for Experimental Study 1. Eight replicate electrochemical-based analytical test strips were tested for plasma or whole blood samples across four Hct levels (from plasma at 0% to 60.2%) and plasma glucose levels (in the range of 53.5-536.5 mg/dl) as described further below.

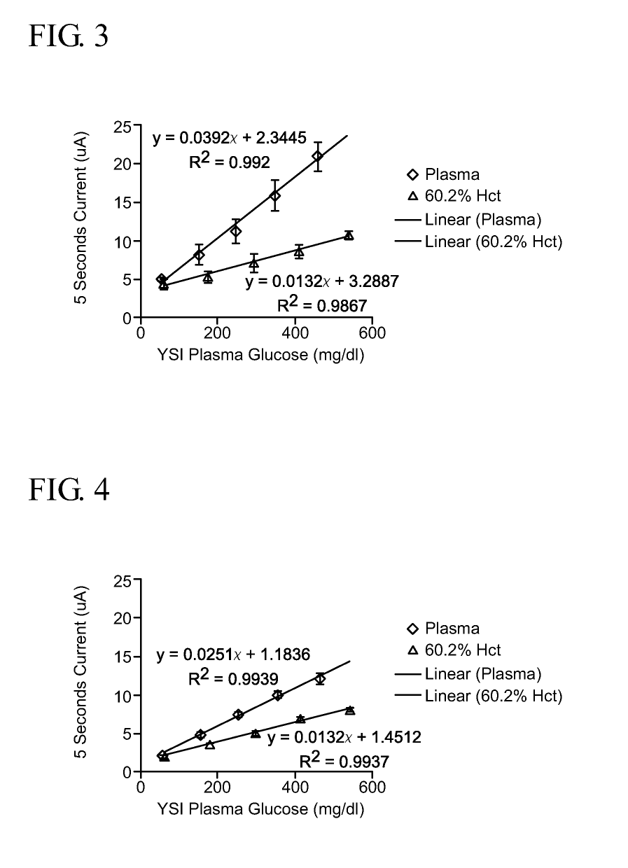

FIG. 3 is a graph of plasma glucose concentration versus 5 second measurement current for an Experimental Study 2 comparison electrochemical-based analytical test strip devoid of a diffusion-controlling layer (DCL). In FIG. 3, the error bars represent the 1^{st} standard deviation of replicates.

FIG. 4 is a graph of plasma glucose concentration versus 5 second measurement current for an Experimental Study 2 electrochemical-based analytical test strip according to an embodiment of the present invention that includes a diffusion-controlling layer (DCL) and a sample-soluble enzymatic reagent layer. The electrochemical-based analytical test strips tested to gather data for FIG. 4 had a DCL thickness of approximately 5.56 μm and the error bars represent 1^{st} standard deviation of replicates

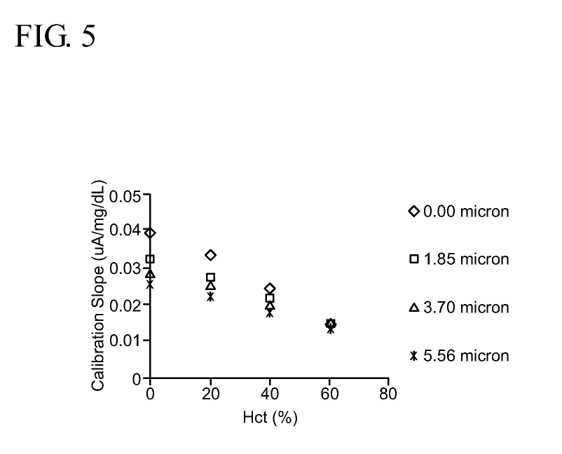

FIG. 5 is a graph of Hematocrit (Hct) percent in a bodily fluid sample versus the associated calibration slope for Experimental Study 2 electrochemical-based analytical test strips according to embodiments of the present invention with DCL thicknesses of 1.85 μm, 3.70 μm, and 5.56 μm, as well as an Experimental Study 2 electrochemical-based analytical test strip devoid of a DCL layer (also referred to as a 0.00 μm thick layer).

The comparison electrochemical-based analytical test strips of Experimental Study 2 (without DCL) exhibited a significant variation in electrochemical response (5 second current in micro-amps) as a function of Hct (see FIG. 3). This is evidenced by the large difference in the calibration slopes in FIG. 3 between a plasma sample (0% Hct) and a blood sample of 60.2% Hct. The difference in calibration slopes is significantly and beneficially less for Experimental Study 2 electrochemical-based analytical test strips in accordance with an embodiment of the present invention that includes a 5.56 μm thick DCL with a DCL (see FIG. 4).

FIG. 5 clearly shows that an increase in DCL thickness reduces the difference in calibration slope across a range of Hct. This is attributed to an increasing reduction in the diffusion rate of ferrocyanide through the DCL with as the DCL thickness is increased.

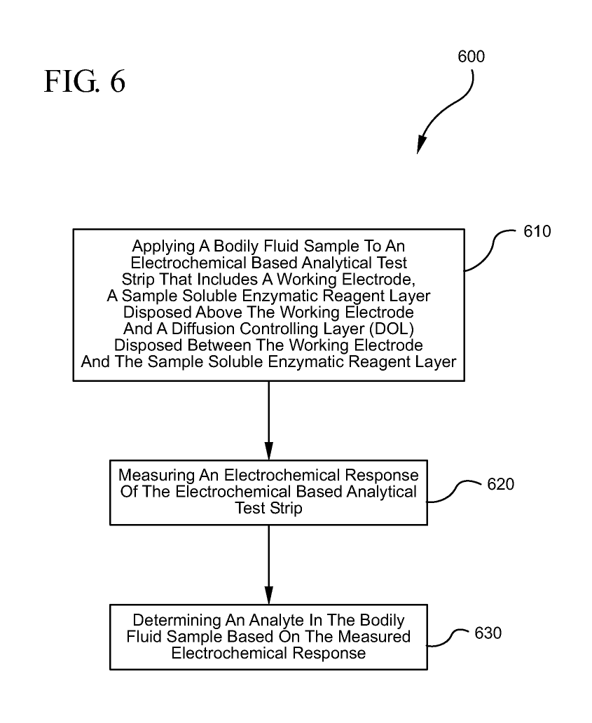

Referring to FIG. 6, a method 600 for determining an analyte (such as glucose) in a bodily fluid sample (for example, a whole blood sample) includes applying the bodily fluid sample to an electrochemical-based analytical test strip that includes a substrate, at least one working electrode disposed on the substrate, a sample-soluble enzymatic reagent layer disposed above the at least one working electrode, a diffusion-controlling layer (DCL) disposed between the at least one working electrode and the sample-soluble enzymatic reagent layer, and a sample-receiving chamber (see step 610 of FIG. 6).

The applying step is such that the applied bodily fluid sample is received in the sample-receiving chamber, the sample-soluble enzymatic reagent layer is operably dissolved in the bodily fluid sample received in the sample-receiving chamber and the dissolved enzymatic reagent engages in an electrochemical enzymatic reaction with an analyte in the bodily fluid sample. In addition, the diffusion controlling layer is configured and constituted to provide a predetermined diffusion rate for a component of the electrochemical enzymatic reaction (e.g., a mediator) through the DCL that is less than the diffusion rate of the component through the bodily fluid sample and for operable hydration by the bodily fluid sample.

Method 600 also includes measuring an electrochemical response (such as a current generated at the working electrode) of the electrochemical-based analytical test strip and determining the analyte based on the measured electrochemical response.

Once apprised of the present disclosure, one skilled in the art will recognize that method 600 can be readily modified to incorporate any of the techniques, benefits and characteristics of electrochemical-based analyte test strips according to embodiments of the present invention and described herein.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that devices and methods within the scope of these claims and their equivalents be covered thereby.

What is claimed is:

1. An electrochemical-based analytical test strip for the determination of an analyte in a bodily fluid sample, the electrochemical-based analytical test strip comprising:
a substrate;
at least one working electrode disposed on the substrate;
a sample-soluble enzymatic reagent layer disposed above the at least one working electrode;
a diffusion-controlling layer (DCL) disposed between the at least one working electrode and the sample-soluble enzymatic reagent layer; and
a sample-receiving chamber defined in the electrochemical-based analytical test strip,
wherein the sample-soluble enzymatic reagent layer is configured and constituted for operable solubility in a bodily fluid sample applied to the electrochemical-based analytical test strip and received in the sample-receiving chamber and for electrochemical enzymatic reaction with an analyte in the bodily fluid sample; and
wherein the diffusion controlling layer is configured and constituted to provide a predetermined diffusion rate for a component of the electrochemical enzymatic reaction through the DCL that is less than a diffusion rate of the component through the bodily fluid sample and for operable hydration by the bodily fluid sample.

2. The electrochemical-based analytical test strip of claim 1 wherein the analyte is glucose, the bodily fluid sample is a whole blood sample and the component is a mediator.

3. The electrochemical-based analytical test strip of claim 2 wherein the mediator is ferrocyanide.

4. The electrochemical-based analytical test strip of claim 2 wherein the whole blood sample has a hematocrit in the range of 1 percent to approximately 60 percent.

5. The electrochemical-based analytical test strip of claim 3 wherein the diffusion rate of the ferrocyanide in the DCL is less than the diffusion rate of ferrocyanide in the whole blood sample with a hematocrit of approximately 60%.

6. The electrochemical-based analytical test strip of claim 1 wherein the DCL has a diffusion coefficient for a component of a predetermined enzymatic reaction that is less than the diffusion coefficient of the component in the bodily fluid sample.

7. The electrochemical-based analytical test strip of claim 6 wherein the analyte is glucose, the bodily fluid sample is a whole blood sample and the component is a mediator.

8. The electrochemical-based analytical test strip of claim 7 wherein the mediator is ferrocyanide.

9. The electrochemical-based analytical test strip of claim 7 wherein the whole blood sample has a hematocrit in the range of 1 percent to approximately 60 percent.

10. The electrochemical-based analytical test strip of claim 9 wherein the diffusion coefficient of the mediator in the DCL is less than the diffusion coefficient of the mediator in the whole blood sample with a hematocrit of approximately 60 percent.

11. The electrochemical-based analytical test strip of claim 9 wherein the diffusion coefficient of ferrocyanide in the DCL is in the range of 1×10⁻⁶ cm²/sec. to 1×10⁻⁸ cm²/sec.

12. The electrochemical-based analytical test strip of claim 1 wherein the DCL is formed of a hydrophilic polymer.

13. The electrochemical-based analytical test strip of claim 11 wherein the DCL has a thickness in the range of 3 microns to 10 microns.

14. A method for determining an analyte in a bodily fluid sample, the method comprising:
applying a bodily fluid sample to an electrochemical-based analytical test strip that includes:
a substrate;
at least one working electrode disposed on the substrate;
a sample-soluble enzymatic reagent layer disposed above the at least one working electrode;
a diffusion-controlling layer (DCL) disposed between the at least one working electrode and the sample-soluble enzymatic reagent layer; and
a sample-receiving chamber defined in the electrochemical-based analytical test strip,
such that the bodily fluid sample is received in the sample-receiving chamber,
wherein the diffusion controlling layer is configured and constituted to provide a predetermined diffusion rate for a component of the electrochemical enzymatic reaction through the DCL that is less than the diffusion rate of the component through the bodily fluid sample and for operable hydration by the bodily fluid sample; and
such that the applied bodily fluid sample is received in the sample-receiving chamber, the sample-soluble enzymatic reagent layer is operably dissolved in the bodily fluid sample received in the sample-receiving chamber and the dissolved enzymatic reagent engages in an electrochemical enzymatic reaction with an analyte in the bodily fluid sample; and
measuring an electrochemical response of the electrochemical-based analytical test strip; and
determining the analyte based on the measured electrochemical response.

15. The method claim 14 wherein the analyte is glucose, the bodily fluid sample is a whole blood sample and the component is a mediator.

16. The method of claim 15 wherein the mediator is ferrocyanide.

17. The method of claim 15 wherein the whole blood sample has a hematocrit in the range of 1 percent to approximately 60 percent.

18. The method of claim 16 wherein the diffusion rate of the mediator in the DCL is less than the diffusion rate of the mediator in the whole blood sample with a hematocrit of approximately 60%.

19. The method of claim 14 wherein the DCL has a diffusion coefficient for a component of a predetermined enzymatic reaction that is less than the diffusion coefficient of the component in the bodily fluid sample.

20. The method of claim 19 wherein the analyte is glucose, the bodily fluid sample is a whole blood sample and the component is a mediator.

21. The method of claim 20 wherein the mediator is ferrocyanide.

22. The method of claim 20 wherein the whole blood sample has a hematocrit in the range of 1 percent to approximately 60 percent.

23. The method of claim 21 wherein the diffusion coefficient of ferrocyanide in the DCL is in the range of 1×10⁻⁶ cm²/sec. to 1×10⁻⁸ cm²/sec.

24. The method of claim 22 wherein the diffusion coefficient of the mediator in the DCL is less than the diffusion coefficient of the mediator in the whole blood sample with a hematocrit of approximately 60 percent.

25. The method of claim 14 wherein the DCL is formed of a polymer.

26. The method of claim 25 wherein the DCL has a thickness in the range of 3 microns to 10 microns.
